(19) United States
(12) Patent Application Publication
(10) Pub. No.: US 2003/0179418 A1
(43) Pub. Date: Sep. 25, 2003

(54) Producing a defective pixel map from defective cluster pixels in an area array image sensor

(75) Inventors: Timothy G. Wengender, Webster, NY (US); Mark A. Newhouse, Rochester, NY (US); Eric J. Meisenzahl, Ontario, NY (US); James E. McGarvey, Hamlin, NY (US)

Correspondence Address: Thomas H. Close, Patent Legal Staff, Eastman Kodak Company, 343 State Street, Rochester, NY, 14650-2201, US

(73) Assignee: Eastman Kodak Company

(21) Appl. No.: 10/100,723

(22) Filed: Mar. 19, 2002

(51) Int. Cl. H04N 1/00; H04N 1/46

(52) U.S. Cl. 358/437; 358/509

(57) ABSTRACT

A method for determining one or more defective pixels in an area array image sensor wherein such defects can form a defective cluster and for producing a defect map which can be used in a digital camera for image correction includes capturing a digital image using the image sensor and storing such digital image in a memory; identifying a plurality of defective pixels which form a defective cluster in the digital image by processing the digital image data using a localized averaging filter; and forming a map identifying the location of the defective cluster in the digital image.

### CROSS REFERENCE TO RELATED APPLICATIONS

Reference is made to commonly assigned U.S. patent application Ser. No. 09/952,342 filed Sep. 14, 2001 by Timothy G. Wengender, the disclosure of which is incorporated herein by reference.

### FIELD OF THE INVENTION

The present invention relates to area array image sensors and, more particularly, to the identification of defective pixels and defective cluster pixels in such image sensors to produce a defect map and for determining the pixels to correct such defects.

### BACKGROUND OF THE INVENTION

An area array image sensor is basically a two dimensional array of pixel sensing elements of size x columns by y rows. One type of area array image sensor is a full frame CCD image sensor. Other types of area arrays sensors include interline CCD image sensors and CMOS image sensors. Full frame image sensors capture light and store the resulting signal electrons in the individual pixel sensors. The pixels are vertically shifted down each column in parallel by one row, with the last row being shifted out and filling a horizontal shift register. These pixels in the horizontal shift register are then shifted out one at a time (serially) until the horizontal shift register is completely empty. At this time, the sensor is ready to fill the horizontal shift register again, and the process of parallel to series shift explained above is repeated one row at a time until all rows of the sensor have been transported out of the sensor.

In typical high resolution image sensors, some of the pixels of the image sensing array provide corrupted data, which is classified into three different types: pixel, column, and defective cluster pixels. These defects are often characteristics of the device and are formed during the manufacturing process. The defects are typically mapped during the manufacturing process, but in some cases additional defects are also detected when the sensors are assembled into the final product, such as a digital camera. For example, the temperature or the clock and timing characteristics of the electronics controlling the sensor can cause additional defects. Also, during the product assembly, dust, dirt, scratches, etc. may be introduced.

With area array image sensors, there is often a problem where there is one or more defective pixels in a local neighborhood. These defects are found in adjacent rows and columns and will be called, in this specification, a defective cluster. More specifically, a defective cluster contains more than one defective pixel touching another adjacent defective pixel horizontally, vertically, or diagonally. Such a defective pixel or defective cluster will cause corrupted data in the digital image after it is read out of the image sensor. To produce the highest quality image, the defective pixels or defective cluster pixels need to be identified and pixels need to be determined therefrom to correct such defects.

### SUMMARY OF THE INVENTION

It is therefore an object of the present invention to automatically determine the defective pixels and defective cluster pixels in an image produced by an image sensor, such as a full frame image sensor, and to map such corrupted data so that it can be corrected in a digital camera.

This object is achieved by a method for determining one or more defective pixels in an area array image sensor wherein such defects can form a defective cluster and for producing a defect map which can be used in a digital camera for image correction, comprising the steps of:

a) capturing a digital image using the image sensor and storing such digital image in a memory;

b) identifying a plurality of defective pixels which form a defective cluster in the digital image by processing the digital image data using a localized averaging filter; and

c) forming a map identifying the location of the defective cluster in the digital image

### ADVANTAGES

It is an important advantage of the present invention to provide a defect map of defective pixels and defective cluster pixels, and to provide correction pixels, which can be used by a defect correction routine that will correct such defects.

It is a further advantage of the present method to determine the location of cluster defects by processing digital image data using a localized mean filter.

A feature of the invention is the provision of a method that quickly, accurately, and automatically identifies defective pixels and defective cluster pixels in an image sensor, so that an effective map of the defective pixels can be provided.

### BRIEF DESCRIPTION OF THE DRAWINGS

FIG. 1 is a schematic diagram that shows examples of types of defective cluster pixels that can be found in a digital image produced by an image sensor;

FIG. 2 is a block diagram of a test system for testing an image sensor in accordance with the present invention for automatically identifying corrupted data in a digital image and providing a defect map which can be used in a digital camera to correct such corrupted data;

FIG. 3 is a block diagram of a digital camera which can be used to capture the image as shown in the test system of FIG. 2 and also store the defect map as created by the block diagram of FIG. 4;

FIG. 4 is a block diagram including the localized mean filter used in the system of FIG. 2 for producing the defect map;

FIG. 5 is a block diagram of the algorithm used to determine the correction pixels for the defect map produced by the block diagram of FIG. 4; and

FIG. 6 is a defect map for the example defects shown in FIG. 1.

### DETAILED DESCRIPTION OF THE INVENTION

In accordance with the present invention, a method is set forth for determining one or more defective pixels in a full frame image sensor. The defects can be individual or can form a defective cluster and are used to form a defect map which can be used in a digital camera for image correction.

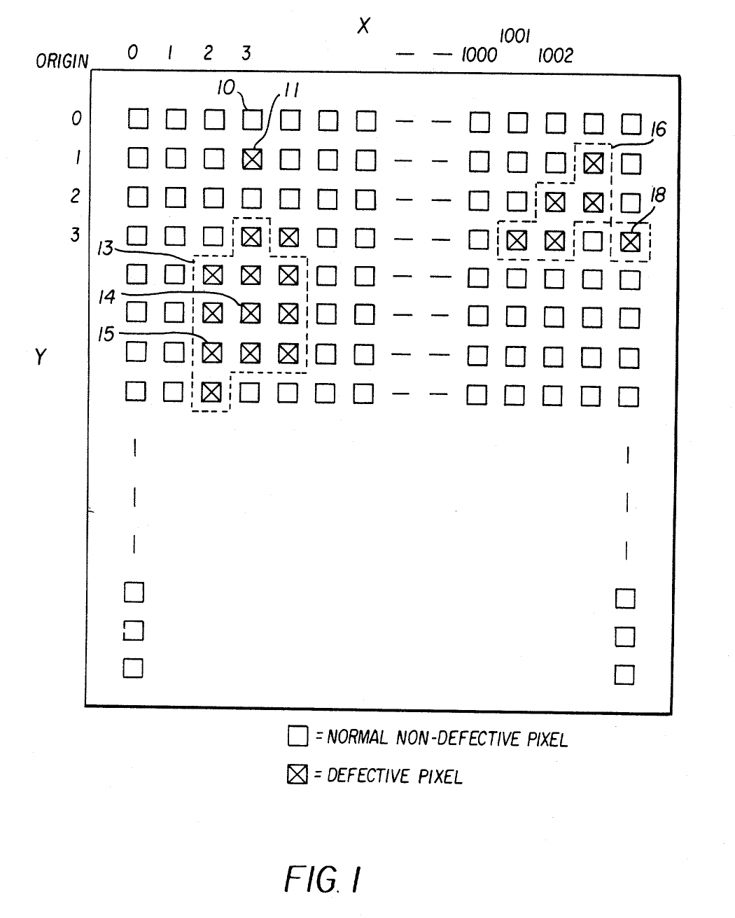

FIG. 1 depicts a schematic diagram to represent the different types of defective cluster pixels observable in an image sensor, such as a full frame image sensor. For a more detailed description of the operation and structure of CCD image sensors, refer to “Solid-State Imaging with Charge-Coupled Devices” by Albert J. P. Theuwissen (1995).

FIG. 1 depicts an image sensor with both non-defective pixels and defective pixels. A normal pixel with uncorrupted data 10 is classified as non-defective. A defective pixel with corrupted data 11 is classified as a single defective pixel. Several defective pixels adjacent to each other and 16 are classified as defective cluster pixels. As shown by defective cluster pixels 13 and 16, defective cluster pixels appear in different shapes and sizes. This is due to the fact that defective cluster pixels are caused by impurities and contamination during the manufacturing process, such as dirt, dust, or a scratch on the sensor surface. Defective pixels 14, 15, and 18 are examples of defective pixels contained in defective cluster pixels. Since defective pixels 14 and 15 have adjacent defective pixels horizontally or vertically and defective pixel 18 has an adjacent defective pixel diagonally, defective pixels 14 and 15 are part of defective cluster 13, and defective pixel 18 is part of defective cluster 16, as defined earlier in the Background of the Invention section.

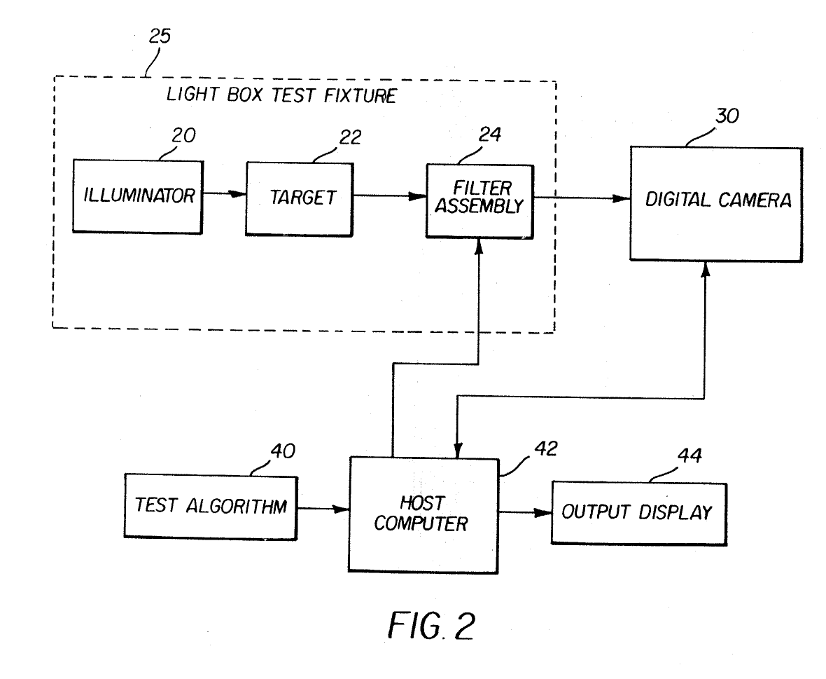

Turning now to FIG. 2, a representative test system is used to acquire an image, process the image and identify corrupted data, and store the corrupted data back into the digital camera as a defect map. The test system includes an illumination source 20, which directs light through a transparent diffuse target 22 used to produce a flat field image. The light intensity is regulated through a filter assembly 24 including several neutral density filters. Filter selection is controlled by a host computer 42. Parts 20, 22, and 24 are all enclosed in a light box test fixture 25 to block unwanted light interference from the outside. The flat field image produced in the light box test fixture 25 is captured and processed by a digital camera 30 (described later). The digital camera 30 is automatically controlled by the host computer 42. The host computer 42 controls both the capture and retrieval of the image from the digital camera 30 via an electrical interface, such as one made in accordance with the well-known IEEE 1394 (Firewire) standard.

Once the image has been retrieved from the digital camera 30, a test algorithm 40 (described later), which has been input to the host computer 42 prior to the beginning of the test, is used to process and analyze the image. The host computer 42 determines the defect map and correction pixels according to the test algorithm 40 and lists the results on the output display 44. A defect map including the locations of correction pixels to be used for correcting the identified defective pixels is also sent to and stored in the digital camera 30.

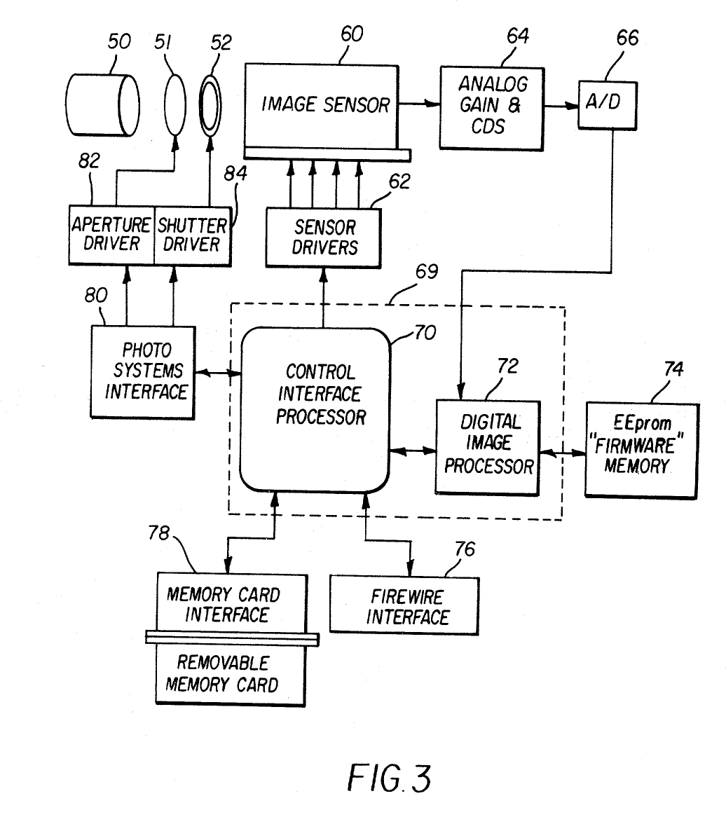

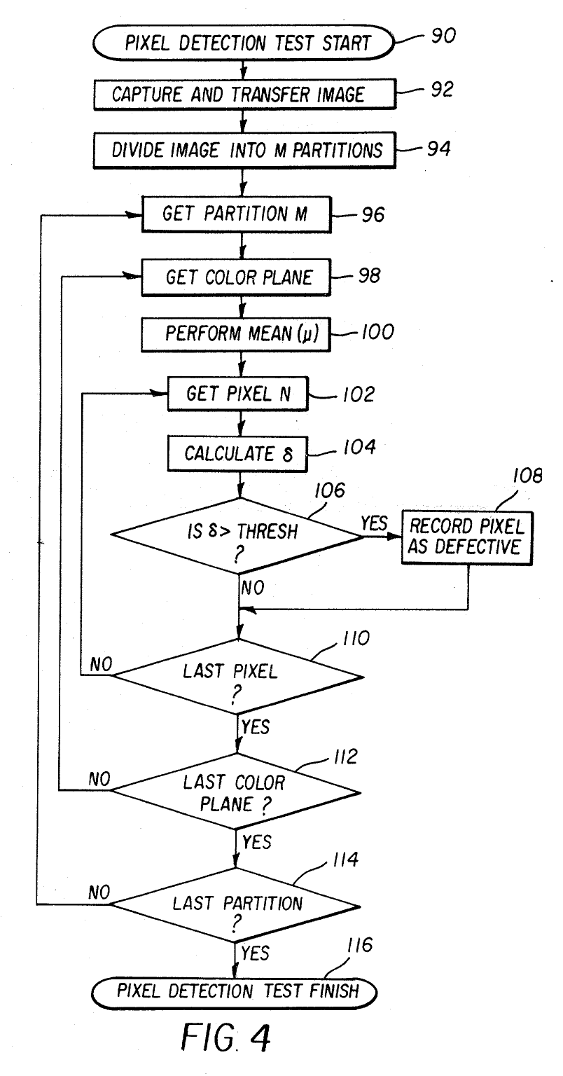

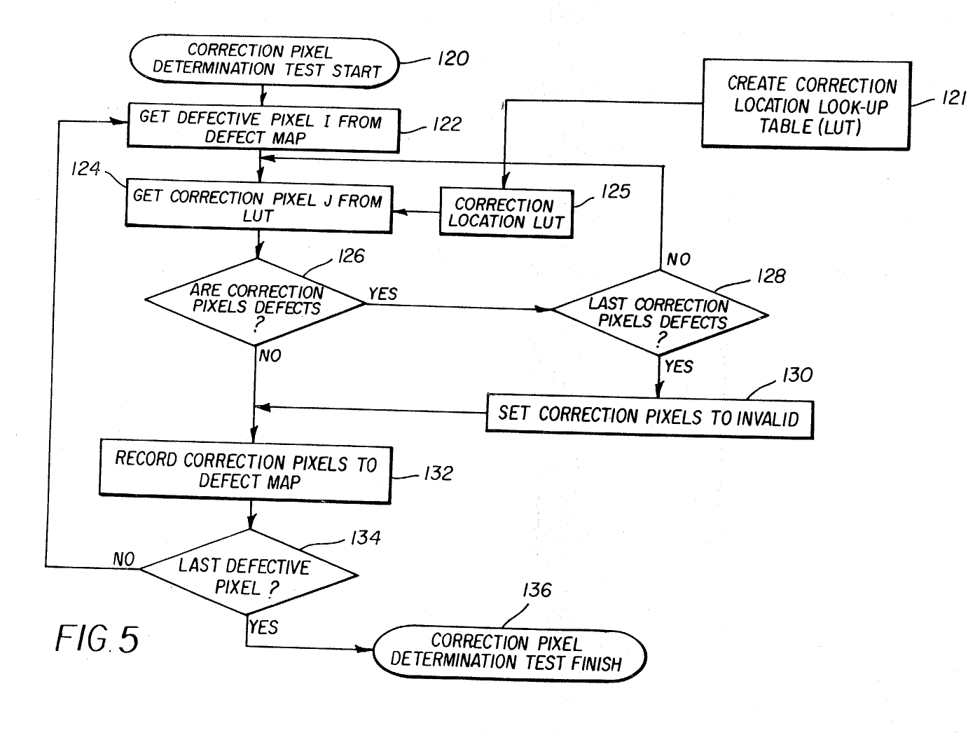

FIG. 3 depicts a block diagram of a digital camera used to capture an image produced by the test system of FIG. 2 described above and store the defect map produced by test algorithm of FIG. 4 (described later), and correction pixels determined by test algorithm of FIG. 5 (described later). As stated above, the host computer 42 automatically controls the operation of the digital camera 30. The host computer 42 sends the digital camera 30 a series of commands via Firewire interface 76 n accordance with the IEEE 1394 standard. The control interface processor 70 interprets these commands and in turn sends commands to a photo systems interface 80, which sets the exposure control parameters for the digital camera 30. Connected to the photo systems interface 80 are an aperture driver 82 and a shutter driver 84. The camera includes an optical lens 50, which receives the incoming light. Through the aperture driver 82 and the shutter driver 84, aperture 51 and shutter 52 are controlled, respectively, and allow the incoming light to fall upon the full frame image sensor 60. The image sensor 60, which can be a KAF-16801CE image sensor manufactured by Eastman Kodak Company, Rochester, N.Y. , is clocked by the sensor drivers 62. The output of the image sensor 60 is amplified and processed in a CDS (correlated double sampling circuit) 64 and converted to a digital form in an A/D converter 66. The digital data is transferred to processor section 69, which includes a digital image processor 72 that utilizes instructions stored in EEPROM Firmware memory 74 to process the digital image. Finally, the processed digital image is stored using a memory card interface and removable memory card 78, which can be made in accordance with the well-known PCMCIA 2.0 standard interface, or the image is transferred back to the host computer 42 shown in FIG. 2 via the Firewire interface 76.

The present invention provides an automated test method for effectively detecting defective pixels and defective cluster pixels in the image sensor 60. FIG. 4 depicts a flowchart of a preferred embodiment including a localized mean filter, which is a preferred type of localized averaging filter, for operating the system of FIG. 2 to detect defective pixels and defective cluster pixels. As will become clearer when FIG. 4 is discussed, blocks 94-116 describe the localized mean filter. Instead of a localized mean filter, other types of localized averaging filters could be used. Examples of localized averaging filters include a localized median filter, which provides a median value of the partition area, and a localized weighted average filter, which provides a center-weighted average of the partition area.

Referring now to the flowchart of FIG. 4, the test starts in block 90 when the digital camera 30 is connected to the host computer 42, and properly positioned relative to the light box test fixture 25.

In block 92 an image is captured with the digital camera 30 with a full frame sensor on a flat field target. Also in block 92 the image is transferred from the digital camera 30 as described above to the host computer 42, where the analysis of the image takes place. The defective cluster pixels and defective pixels can be brighter or darker than the surrounding image. For this reason, it is preferred to have several images taken at different exposure levels, each one to be analyzed separately. Typically a low, mid-range, and high exposure image for each gain setting (e.g. each effective ISO setting) of the camera is sufficient. The final defect map includes the defective pixels and defective cluster pixels identified for each of these exposure levels.

In block 94, the host computer 42 divides the image into M partitions. The partitioned image needs to be used rather than the whole image due to the non-uniformity introduced from the test system of FIG. 2. Non-uniformity is introduced with lens roll-off or light source impurities, and for practical applications the flat-field image created is not truly “flat-field”. The number of partitions M depends on the size of the sensor and the size of the partitions. The size of the sensor is given, however, the size of the partition depends on several factors which include: the maximum size of the defective cluster; the defective pixel values of the defective cluster; and the amount of non-uniformity in the image. Each partition will have a mean value calculated, known as a local mean (described below in block 100). The desired result for the local mean calculation is the mean of the non-defective pixels. If the partition is too small and the defective pixel values are too large, the defective pixel values could skew the results. If the partition is too large, the roll-off or light non-uniformities could skew the results. In a preferred embodiment for the KAF-16801CE sensor, the image is divided into 900 partitions. In block 96, the first partition is obtained. Since the image sensor 60 uses a color filter array (CFA), such as the Bayer CFA pattern shown in commonly-assigned U.S. Pat. NO. 3,971,065, and the color pixel values have not been interpolated, there will be four color planes for each partition extracted. Each partition will have a green plane, a red plane, a second different green plane, and a blue plane. The first color plane is extracted in block 98 and a mean value is calculated for it in block 100. The mean value for each partition is referred to as the local mean. In block 102 the first pixel in the partition is extracted. Next, the pixel value from block 102 is compared to the local mean from block 100 by calculating a relative error in block 104 using the formula:

δ=(X0=X)/X (equation 1)

wherein:

δis the relative error;

X0 is the local mean; and

X is the pixel value.

As described earlier, other types of localized averaging filters, such as a localized median filter, could be used instead of the localized mean filter. Furthermore, the localized averaging filter could use a moving partition window, which is shifted for each pixel being compared. However, this is not preferred since it increases the time needed to determine the defects.

In block 106 the relative error is then compared to a threshold to determine whether or not the pixel has corrupt data in it. If the relative error is above a limit threshold, which is typically around 10 percent in the preferred embodiment but will vary depending on gain setting (effective ISO speed), exposure level, and camera type, the pixel is marked as defective. The defective pixel address is recorded in the memory of the host computer 42 as shown in block 108.

The process continues for each pixel in this color plane. In block 110, the program then checks to see if this is the last pixel in this color plane, and if not continues on to the next pixel repeating the process starting at block 102.

After each pixel is analyzed in one color plane, the next color plane is extracted in the same partition. In block 112, the program checks to see if this is the last color plane in this partition, and if not continues on to the next color plane, repeating the process starting at block 98.

After each color plane is analyzed in one partition, the next partition is extracted. In block 114, the program checks to see if this is the last partition in the image, and if not continues on to the next partition repeating the process starting at block 96.

Finally, after the last partition has been analyzed in block 114, the test finishes in block 116. At this point, the final defect map with all the defective pixels and defective cluster pixels has been recorded and stored in the memory of the host computer 42 of FIG. 2.

Turning now to FIG. 5, a method for determining correction pixels for the defect map produced from FIG. 4 is performed. The test starts in block 120 with the final defect map that contains the defective pixels, including defective pixels which are part of defective clusters produced from the block diagram of FIG. 4, and is now stored in memory on the host computer 42.

In block 121, a correction location look-up table (LUT) 125 is created to provide potential correction pixels for each defective pixel of the image sensor 60. Correction location LUT 125 provides an array of entries that can be used for correcting defective pixels, with each entry indicating the offsets from the defective pixel to the location of two nearby pixels that could potentially be used to correct the defective pixel. The entries are listed in order of preference, with the most preferred pair of correction pixel locations listed as the first entry in the array. The first entry corresponds to the pixels of the same color that are horizontally adjacent to the defective pixel, and the second entry corresponds to the pixels of the same color that are vertically adjacent to the defective pixel. Correction location LUT 125 is normally created one time, during the development of the digital camera 30, and is used to determine correction pixels for all defective pixels of the image sensors 60 in all digital cameras 30.

In block 122 the first defective pixel in the defect map is extracted. Next, the first pair of correction pixels is extracted in block 124 from the first entry in the array of entries in the correction location LUT 125. As just described, the correction location LUT 125 is comprised of an array of entries, with each entry identifying two correction pixel locations, relative to the location of the defective pixel. The two correction pixels of the selected entry will be used later by a defect correction routine in the digital camera 30, which will replace the defective pixel value with the average of the two correction pixels determined using the flow diagram of FIG. 5. As mentioned above, the pairs of correction pixels in the correction location LUT 125 are arranged in order of preference, with the first pair being the most preferred. The order of preference has been determined to minimize correction artifacts that are produced during the correction process. To minimize correction artifacts, correction pixels that are closest to the defective pixel are selected, so that spatial transitions that occur in neighboring pixels will be matched in the defective pixel being corrected. This insures that abrupt changes in hue or luminance, i.e. edges, are preserved as much as possible, and that noticeable smearing does not occur. In the preferred embodiment, the digital camera 30 uses software pixel correction in the digital image processor 72 (sometimes referred to as camera firmware), which will be described later in reference to FIG. 7. In block 126 the program checks to see if at least one of the correction pixels provided in block 124 are in the defect map. If one of the correction pixels is in the defect map (meaning that one of the correction pixels is also defective, for example, if it is part of the same cluster defect) then in block 128 the program checks to see if this is the last pair of correction pixels provided by the last entry in correction location LUT 125. If it is not the last entry, the program returns to block 124 to get the next entry in LUT 125, containing the next pair of correction pixels which are then compared in block 126 with the defect map.

If in block 128, this is the last entry in correction location LUT 125, corresponding to the last pair of acceptable correction pixel locations, the correction pixels are set to invalid in block 130 and recorded as such to the defect map in block 132, since the routine could not find a pair of correction pixels that were not defects. Invalid pixel addresses are recorded so that when the digital camera 30 captures an image and processes the image in FIG. 3, the digital camera 30 will not attempt to correct the defective pixel with another defective pixel. In the preferred embodiment, invalid correction pixel addresses are recorded as the defective pixel address. This indicates that the image sensor 60 in the digital camera 30 includes a cluster defect that cannot be acceptably corrected using nearby pixel values. Typically, the image sensor 60 is then replaced with another image sensor, and the camera is re-tested.

Referring back to block 126, if the correction pixels are not in the defect map, then in block 132 these last selected correction pixel addresses from the correction location LUT 125 are recorded in the defect map entry for this particular defective pixel. Therefore, the defect map now identifies both the location of the defective pixel and the locations (via offset values) of two pixels to be used to correct this defective pixel. In block 134, the program checks to see if this is the last defective pixel on the image sensor 60, and if not continues on to the next defective pixel, repeating the process starting at block 122.

Finally, after the last defective pixel has been analyzed in block 134, the test finishes in block 136. At this point, a final defect map with all the defective pixels (including defective cluster pixels) and the correction pixels for such defective pixels (and defective cluster pixels) have been recorded and stored in the memory of the host computer 42 of FIG. 2.

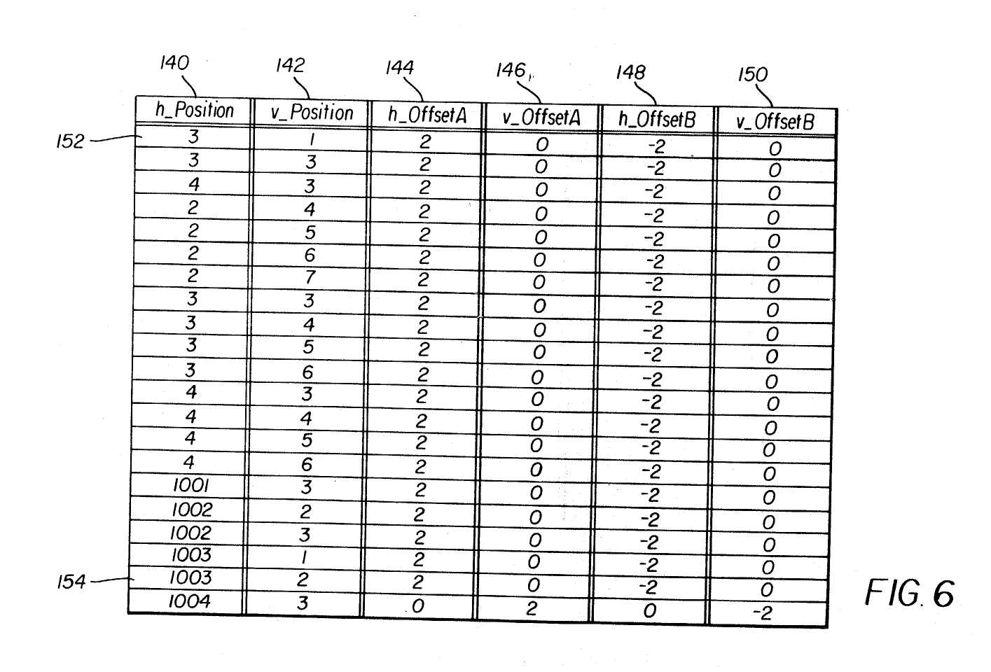

FIG. 6 depicts a defect map for the example defects shown in FIG. 1. The defect map contains all the defective pixel addresses and defective cluster pixel addresses with their corresponding correction pixels addresses. In FIG. 6 each row identifies a defective pixel (which can be part of a defective cluster) and each column defines the x,y address for that defective pixel and also identifies two correction pixel addresses, expressed as horizontal and vertical offset values. In column 140 of the defect map of FIG. 6, the column heading h₁₃Position defines the x address and in column 142 the column heading v₁₃Position defines the y address for the defective pixel which can be part of a defective cluster. In column 144 the column heading h₁₃OffsetA defines the offset to be added or subtracted from the defective pixel position value to provide the first correction pixel x address. In column 146 the column heading v₁₃OffsetA defines the offset to be added or subtracted from the defective pixel to provide the first correction pixel y address. Similarly, in column 148 the column heading h₁₃OffsetB and in column 150 the column heading v₁₃OffsetB define the second correction pixel address for x and y, respectively.

In FIG. 1, an x,y coordinate system is shown with the origin at x=0 and y=0 in the upper left corner of the image. Each pixel in the image of FIG. 1 has an x,y address referenced from the origin. Thus, defective pixel 11 has an address of 3,1 using the x,y coordinate system of FIG. 1. Referring back to FIG. 6, the location of defective pixel 11 is identified in row 152. From the defect map of FIG. 6 defective pixel 11 is identified as having an address of 3,1 and correction pixel address are identified as having offsets of 2,0 and −2,0 relative to this defective pixel address. The x,y addresses of the identified correction pixels for defective pixel 11 are therefore equal to 1,1 and 5,1. Note that horizontally adjacent pixels 2,1 and 4,1 are not used to correct defective pixel 11, since they differ in color as a result of the Bayer color filter pattern being used on image sensor 60.

Row 154 in FIG. 6 identifies defective pixel 18 of FIG. 1, which is a defective cluster pixel since it is included in defective cluster 16. Defective pixel 18 is identified as having an address of 1004,3 and correction pixel address offsets of 0,2 and 0,−2. Note that most of the defective pixels in FIG. 6 have correction pixel address offsets of 2,0 and −2,0 because this is the first pair of correction pixels in the LUT of block 125. Only defective cluster pixel 18 requires a different pair of correction pixels from LUT 125 other than 2,0 and −2,0 because there is a defective pixel located at −2,0.

While the defect map shown in FIG. 6 is a list having one entry row for each defective pixel, many other types of defect maps can alternatively be used. These include maps that group together several defective pixels of a defective cluster, or that use alternative structures to identify defect locations, such as the offsets between one defect location and the next. The map can be provided using many different types of software structures instead of the table format shown in FIG. 6.

The defect map of FIG. 6, including the locations of correction pixels (columns 142-150) for each defective pixel (including defective cluster pixels) is now transferred from the host computer 42 to the digital camera 30 and stored in the EEPROM Firmware memory 74. The digital camera 30 can now use the defect map and the corresponding correction pixels for each defective pixel (including defective cluster pixels) from the EEPROM memory 74 to automatically correct such defective pixels using digital image processor 72, every time a picture is taken.

The following is a defect correction algorithm written in program language C, which can be used by the digital image processor 72 to correct the defective pixels, including the defective cluster pixels:

| | |
|---|---|
| 1 | typedef struct |
| 2 | { |
| 3 | UCHAR type; |
| 4 | UCHAR isoCode; |
| 5 | USHORT hPosition; |
| 6 | char hOffsetA; |
| 7 | char hOffsetB; |
| 8 | USHORT vPosition; |
| 9 | char vOffsetA; |
| 10 | char vOffsetB; |
| 11 | char recorrection; |
| 12 | } defectDescriptor; |
| 13 | |
| 14 | defectDescriptor *defect; |
| 15 | USHORT pixel[4080][4080]; |
| 16 | |
| 17 | pixel[y][point->hPosition + x] |
| 18 | |
| 19 | while (defect->type == 1) |
| 20 | { |
| 21 | pixel[point->vPosition][point->hPosition] = |

| | |
|---|---|
| 22 | (pixel[point->vPosition + defect->vOffsetA][point->hPosition + defect->hOffsetA] + |
| 23 | pixel[point->vPosition + defect->vOffsetB][point->hPosition + defect->hOffsetB] + 1)>> 1; |
| 24 | |

| | |
|---|---|
| 25 | defect++; |
| 26 | } |

First a structure defectDescriptor is defined in lines 1-12 to enable the defect map to be used for defect correction. Within the structure are the members hPosition, vPosition, hOffsetA, vOffsetA, hOffsetB, and vOffsetB, which have the same meanings as described above in reference to FIG. 6. Next, a pointer named defect, having type defectDescriptor, and a two-dimensional array named pixel are declared in lines 14-15. Pixel represents the image pixels for the digital image. In the preferred embodiment, an array size of 4080 by 4080 is created for the KAF-16801CE image sensor 60.

In the preferred embodiment, a defect of type 1 is defined as a defective pixel including a defective pixel that is part of a defective cluster. The defect correction algorithm in FIG. 7 uses a while loop (lines 19-25 ) to replace each defective pixel in the digital image with the average of the two correction pixels, if the defect member type equals 1. Within the while loop, the offset addresses are added to the defective pixel addresses (lines 22-23) to calculate the correction pixel address and access the correction pixel value. Correction pixel value A is added to correction pixel value B plus one. A value of one is added for rounding purposes. Averaging is efficiently accomplished by shifting the resulting sum one bit to the right and the image pixel is assigned this resulting value. The defect pointer is then incremented (line 25) to check the next defective pixel and the while loop continues until all defective pixels and defective cluster pixels have been corrected.

In alternative embodiments, the digital image processor 72 in the digital camera 30 could use a hardwired circuit to perform defect correction, instead of the software algorithm shown in FIG. 7, or the defect correction could be performed in a separate device, such as a computer, which receives the image from the digital camera.

Those skilled in the art will appreciate that the present method can be used to detect and correct both individual defective pixels, and defective pixels that are part of a defective cluster.

A computer program product, such as a readable storage medium, can store the programs in accordance with the present invention for operating the methods set forth above. The readable storage medium can be a magnetic storage media, such as a magnetic disk (such as a floppy disk) or magnetic tape; optical storage media, such as an optical disk, an optical tape, or a machine readable bar code; solid state electronic storage devices, such as a random access memory (RAM) or a read only memory (ROM); or any other physical device or medium employed to store computer programs.

The invention has been described in detail with particular reference to certain preferred embodiments thereof, but it will be understood that variations and modifications can be effected within the spirit and scope of the invention.

### PARTS LIST

10 normal non-defective pixel

11 defective pixel

13 defective cluster

14 defective cluster pixel

15 defective cluster pixel

16 defective cluster

18 defective cluster pixel

20 illuminator

22 target

24 filter assembly

25 light box test fixture

30 digital camera

40 test algorithm

42 host computer

44 output display

50 optical lens

51 aperture

52 shutter

60 image sensor

62 sensor drivers

64 analog gain and CDS

66 A/D converter

69 processor section

70 control interface processor

72 digital image processor

74 EEPROM Firmware memory

76 Firewire interface

78 removable memory card and interface

80 photo systems interface

82 aperture driver

84 shutter driver

90 block

92 block

94 block

96 block

98 block

100 block

102 block

104 block

106 block

108 block

110 block

112 block

114 block

116 block

120 block

121 block

122 block

124 block

125 block

126 block

128 block

130 block

132 block

134 block

136 block

140 block

142 block

144 block

146 block

148 block

150 block

152 block

154 block

What is claimed is:

1. A method for determining one or more defective pixels in an area array image sensor wherein such defects can form a defective cluster and for producing a defect map which can be used in a digital camera for image correction, comprising the steps of:
a) capturing a digital image using the image sensor and storing such digital image in a memory;
b) identifying a plurality of defective pixels which form a defective cluster in the digital image by processing the digital image data using a localized averaging filter; and
c) forming a map identifying the location of the defective cluster in the digital image.

2. The method of claim 1 wherein the image sensor is a full frame CCD image sensor.

3. The method of claim 1 wherein the location of the defective cluster is identified by identifying the location of each detective pixel in the defective cluster.

4. The method of claim 1 further including the step of storing the map in a digital camera and using the map to correct the defective clusters.

5. The method of claim 4 wherein the map provides the locations of correction pixels to be used to correct the defective clusters.

6. The method of claim 1 wherein the localized averaging filter is a localized mean value.

7. A method for determining a defect map for an area array image sensor wherein such defects can form a defective cluster and wherein such defect map can be used in a digital camera for image correction, comprising the steps of:
a) capturing a digital image using the image sensor and storing such digital image in a memory;
b) identifying at least two pixels forming a defective cluster in the digital image which have corrupted data by processing the digital image data using a localized averaging filter; and
c) forming a map of the defective cluster pixels.

8. The method of claim 7 further including correcting in the digital camera the defective cluster pixels, by the steps of:
d) using the map to identify the locations of correction pixels to be used to correct such corrupt data; and
e) using the correction pixels to correct such defective cluster pixels.

9. The method of claim 8 wherein the pixels are corrected using an average of the identified correction pixels and replacing each defective pixel value with a corrected pixel value.

10. The method of claim 7 wherein the output of the localized averaging filter is compared to a threshold determined from the digital image data.

11. The method of claim 7 wherein the image sensor is a color image sensor, and step b) is performed on separate color plane image data.

13. The method of claim 7 wherein the localized averaging filter is a localized mean value.

14. A computer program product comprising a computer readable storage medium having a computer program stored thereon for implementing the method of claim 1.
